(19) United States
(12) Patent Application Publication
(10) Pub. No.: US 2025/0036904 A1
(43) Pub. Date: Jan. 30, 2025

(54) Printing marks on substrate edge

(71) Applicant: LANDA CORPORATION LTD., Rehovot (IL)

(72) Inventors: Yossi Dror, Kiryat Ono (IL); Matan Bar-On, Hod Hasharon (IL)

(21) Appl. No.: 18/835,038

(22) PCT Filed: Jan. 23, 2023
(86) PCT No.: PCT/IB2023/050536

§ 371 Date: Aug. 1, 2024

Related U.S. Application Data
(60) Provisional application No. 63/307,126, filed on Feb. 6, 2022.

(51) Int. Cl. G06K 15/00; B41J 2/21; B41M 3/00; G06K 15/02

(52) U.S. Cl. CPC G06K 15/408; B41J 2/2135; B41M 3/008; G06K 15/027

(57) ABSTRACT

A system (10) includes a printing assembly (13) and a stacking assembly (59). The printing assembly (13) is configured to print: (i) multiple images on multiple respective substrates (50), and (ii) multiple marks on one or more edges of the multiple respective substrates. The stacking assembly (59) is configured to stack the multiple respective substrates on top of one another to form a stack (88) having a top surface (32) parallel to one or more of the substrates, and sides (21, 31, 41, 51) made from the stacked edges of the substrates. One or more of the marks are visible on a side-view of at least a given side (21) of the sides, and at least a position of the one or more marks in the side view of the given side, is indicative of a problem that occurred while printing one or more of the multiple images.

### CROSS-REFERENCE TO RELATED APPLICATIONS

This application claims the benefit of U.S. Provisional Patent Application 63/307,126, filed Feb. 6, 2022, whose disclosure is incorporated herein by reference.

### FIELD OF THE INVENTION

The present invention relates generally to digital printing, and particularly to methods and systems for controlling printing processes using marks printed on edges of a substrate.

### BACKGROUND OF THE INVENTION

Various techniques for printing on an edge of a substrate and controlling printing processes have been published.

For example, U.S. Pat. No. 5,243,394 describes an electrophotographic device records linear marks, according to jobs, at an edge of at least one side of a sheet. By designating according to jobs, the sorting of recorded sheets which are stacked up in a stacker is facilitated. The sheets are fed one after another by a carrier device, and thereafter an edge of the sheet is detected by a paper tip detecting device or a paper side edge detecting device. Based on the detected position of the paper edge, a linear mark K, corresponding to a position designated by a control device, is recorded on the sheet.

U.S. Patent Application Publication 2008/0053327 describes a method of identifying sheets within a stack of printed sheets for sorting or further evaluation. In an embodiment the method comprises printing non-test production printing job(s) on sheets of media and outputting the printed sheets into a stack of sheets. The method monitors the printing of the non-test production printing jobs and, upon the occurrence of a “predetermined event” during the monitoring, adds a unique marking at an edge region of a printed sheet (of the non-test production printing jobs) being printed to create an identifier sheet from one of the sheets of the non-test production printing jobs. The unique marking is visible from the side of the stack of sheets. The identifier sheet is then output to the stack of sheets with the other sheets of the non-test production print job. During the remainder of the printing of the non-test production print job the method continues the printing of the sheets and the monitoring. After the printing is completed, the identifier sheet can be subjected to specific inspection or can be used to indicate a specific sheet count within the stack of sheets. Then the stack of sheets can be subjected to subsequent processing such as trimming and binding, wherein the trimming process removes the edge region from the printed sheets.

U.S. Patent Application Publication 2010/0141985 describes a method for separating multiple print jobs sent by one or more computers to a document printer, the method including printing a first banner at the edge of a top sheet of a first print job, and printing a second banner at the edge of a top sheet of a second print job.

### SUMMARY OF THE INVENTION

An embodiment of the present invention that is described herein provides a system including a printing assembly and a stacking assembly. The printing assembly is configured to print: (i) multiple images on multiple respective substrates, and (ii) multiple marks on one or more edges of the multiple respective substrates. The stacking assembly is configured to stack the multiple respective substrates on top of one another to form a stack having a top surface parallel to one or more of the substrates, and sides made from the stacked edges of the substrates. One or more of the marks are visible on a side-view of at least a given side of the sides, and at least a position of the one or more marks in the side view of the given side, is indicative of a problem that occurred while printing one or more of the multiple images.

In some embodiments, the images include first and second images, the marks include first and second marks, and the substrates include first and second substrates, respectively, and: (i) on the first substrate, the first image is printed at an intended position and the first mark is printed at a first edge position on a given edge of the edges, and (ii) on the second substrate, the second image is printed at an actual position and the second mark is printed on the given edge at a second edge position. In other embodiments, the problem includes an offset between the intended position and the actual position, and in the side-view image, a difference between the first and second edge positions is indicative of the offset between the actual position and the intended position. In yet other embodiments, the first image includes a first color image of a first color and a second color image of a second color, different from the first color, the first mark includes: (i) a first color mark that is associated with the first color image and is located at a first color position, and (ii) a second color mark that is associated with the second color image and is located at a second color position different from the first color position. The problem includes a registration error between the first and second color images, and in the side-view image, a distance between the first and second color positions is indicative of the registration error between the first and second color images.

In some embodiments, the problem includes a movement of the second substrate relative to the second image, and a difference between the first and second edge positions in the side-view image, is indicative of the movement. In other embodiments, the movement includes a rotation of the second substrate about an axis orthogonal to the top surface. In yet other embodiments, the first image is printed on the first substrate using a first printing job, and the second image is intended to be printed on the second substrate using a second printing job, different from the first printing job, the problem includes an operational error of using the first printing job for printing the second image on the second substrate, and a difference between the first and second edge positions is indicative of the operational error.

In some embodiments, the system includes a processor, which is configured to receive a side-view image of the side view, and to identify the problem based on at least the position of the one or more marks in the side-view image. In other embodiments, before printing the multiple marks, the processor is configured to define one or more properties of the multiple marks intended to be printed on the one or more edges. In yet other embodiments, the one or more properties include at least one of: (i) the position of the one or more marks in the side view, (ii) a size of the one or more marks in the side view, and (iii) a color of the one or more marks in the side view.

In some embodiments, at least one of the marks includes a machine-readable label (MRL), which is configured to contain information about at least one of: (i) one or more properties of at least one of the substrates, (ii) one or more properties of at least one of the images, (iii) one or more properties of at least one of the marks, (iv) one or more properties of the problem, and (v) one or more administrative properties of at least a portion of the stack. In other embodiments, the MRL includes at least one of: (i) a machine-readable optical label, and (ii) a machine-readable magnetic label.

In some embodiments, the system includes a processor, which is configured to receive a signal indicative of the information contained in the MRL, and to display the information to a user. In other embodiments, the information contained in the MRL includes at least a control limit indicative of a level of the problem based on the one or more properties of the marks. In yet other embodiments, the one or more administrative properties include properties of at least one of: (i) a printing job of the portion of the stack, and (ii) a client of the portion of the stack.

There is additionally provided, in accordance with an embodiment of the present invention, a method, including printing: (i) multiple images on multiple respective substrates, and (ii) multiple marks on one or more edges of the multiple respective substrates. The multiple respective substrates are stacked on top of one another to form a stack having a top surface parallel to one or more of the substrates, and sides made from the stacked edges of the substrates, and one or more of the marks are visible on a side-view of at least a given side of the sides. A problem that occurred while printing one or more of the multiple images, is identified based on at least a position of the one or more marks in the side view of the given side, which is indicative of the problem.

The present invention will be more fully understood from the following detailed description of the embodiments thereof, taken together with the drawings in which:

### BRIEF DESCRIPTION OF THE DRAWINGS

FIG. 1 is a schematic side view of a digital printing system, in accordance with an embodiment of the present invention;

FIGS. 2A and 2B are schematic side views of an output stack of printed sheets having a pattern of marks printed on an edge of one or more of the printed sheets, in accordance with an embodiment of the present invention; and

FIG. 3 is a flow chart that schematically illustrates a method for producing and using the marks for identifying process problems and distortions occurred in images printed on the sheets, in accordance with an embodiment of the present invention.

### DETAILED DESCRIPTION OF EMBODIMENTS

### Overview

Printing processes, such as digital printing that apply droplets of ink to a substrate for producing an image thereon, may comprise multiple printing jobs having different printing settings, and optionally, different images printed in at least two of the printing jobs. The printed sheets are typically stacked in an output stack of the printing system.

In principle, it is possible to insert within the output stack, mechanical tabs between the printing jobs, e.g., using a suitable tab-inserting assembly of the printing system, or using a dedicated system for tab inserting. Moreover, digital printing processes may have problems, such as process problems and equipment failures that may cause distortions in the printed images. Some of the process problems and/or distortions may not be detectable during the printing process, or may require inspection of each sheet immediately after the sheet has been printed.

Embodiments of the present invention that are described hereinafter provide methods and systems for replacing the mechanical tabbing with a digital tabbing process by printing marks on one or more edges of the sheets. In some embodiments, the edge-printed marks may be designed for detecting some problems in the printing process and equipment failure, as well as distortions that may occur during the printing process.

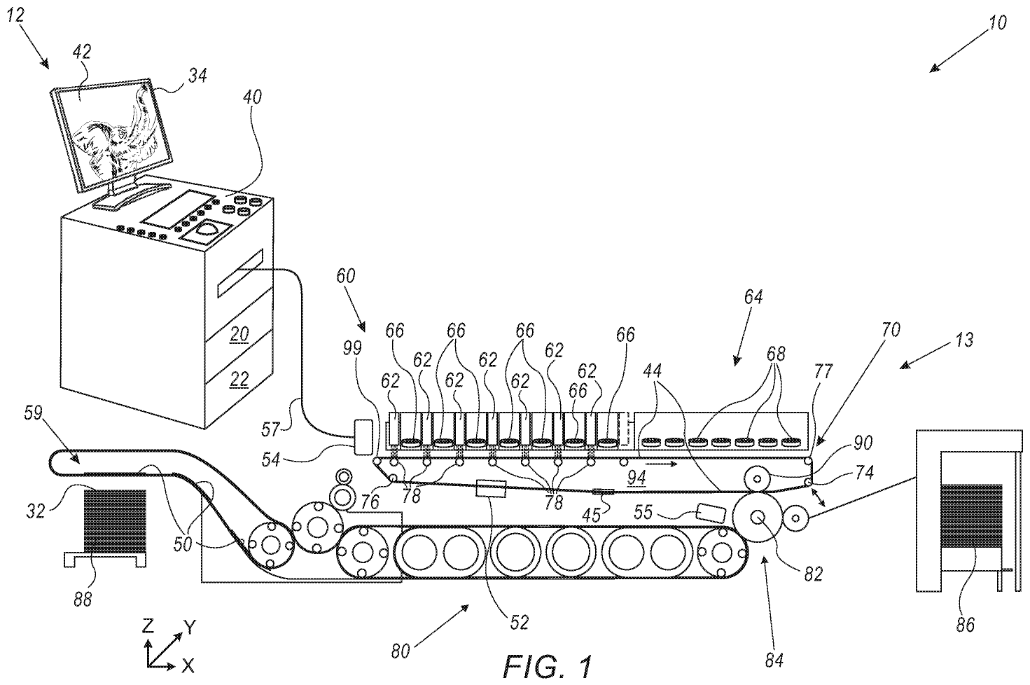

In some embodiments, a digital printing system comprises a printing assembly having an image forming station configured to apply droplets of printing fluids (e.g., jetting ink droplets) to a surface of a movable closed loop of a flexible intermediate transfer member (ITM), also referred to herein as a blanket, for producing an image thereon. The blanket is described in more detail in FIG. 1 below.

In some embodiments, the digital printing system further comprises: (i) an impression station, configured to transfer the image from the blanket to a target substrate (e.g., a sheet), (ii) a blanket module configured to move the blanket for producing the image thereon and transferring the image to the sheet, (ii) input and output stacks of the sheets before and after receiving the image, respectively, (iv) a stacking assembly, configured to stack the sheets, who received the respective images, in the output stack, and (v) a substrate transfer module configured to move the sheets from the input stack, via the impression station, and to the output stack.

In some embodiments, when the printed sheets are stacked in the output stack on top of one another, the output stack has a top surface, which is typically parallel to the surface of the sheets on which the image is printed. The multiple edges of the stacked sheets form, in the output stack, multiple respective sides. For example, the sheets have a rectangular shape with four edges, and the output stack of the sheets has four sides corresponding to the four edges.

In some embodiments, the digital printing system further comprises, a processor, which is configured to receive multiple images, such as product images that are intended to be printed on multiple respective sheets, and multiple marks that are intended to be printed on edges of the sheets. In some embodiments, after concurrently printing the images on the sheets and the marks on one or more edges of the sheets, the marks are visible on a side view of the output stack of the sheets. Moreover, the marks printed on the edge of the sheets jointly form a pattern having a graphic representation on the respective side of the output stack.

In some embodiments, the graphic representation is indicative of one or more problems that may have occurred in the printing process. For example, a distance between two of the marks may be indicative of a distortion in one or more of the printed images.

In some embodiments, the processor is configured to control the printing assembly, impression station, blanket module, stacking assembly, substrate transfer module, and other elements of the system to carry out the printing process, and to stack the sheets having the printed images in the output stack.

In some embodiments, the printed marks may jointly form on one or more of the sides of the output stack, a graphic representation of the position and orientation of the sheet, relative to the intended position and orientation thereof. In other words, the pattern formed on the side by the printed marks may be indicative of a misalignment between at least two of the sheets in the output stack. For example, when the printed sheets are stacked, the marks produce a graphic representation indicative of a registration error in the printed image (described in the detailed description), and/or unintended movement (e.g., rotation and/or translation) of one or more of the sheets.

In some embodiments, based on the graphic representation of the marks in the output stack. (i) an operator of the system may identify process problems and image distortions, and/or (ii) the processor may receive a side-view image of the edge(s) of the output stack, and identify the process problems and/or image distortions by analyzing the side-view image.

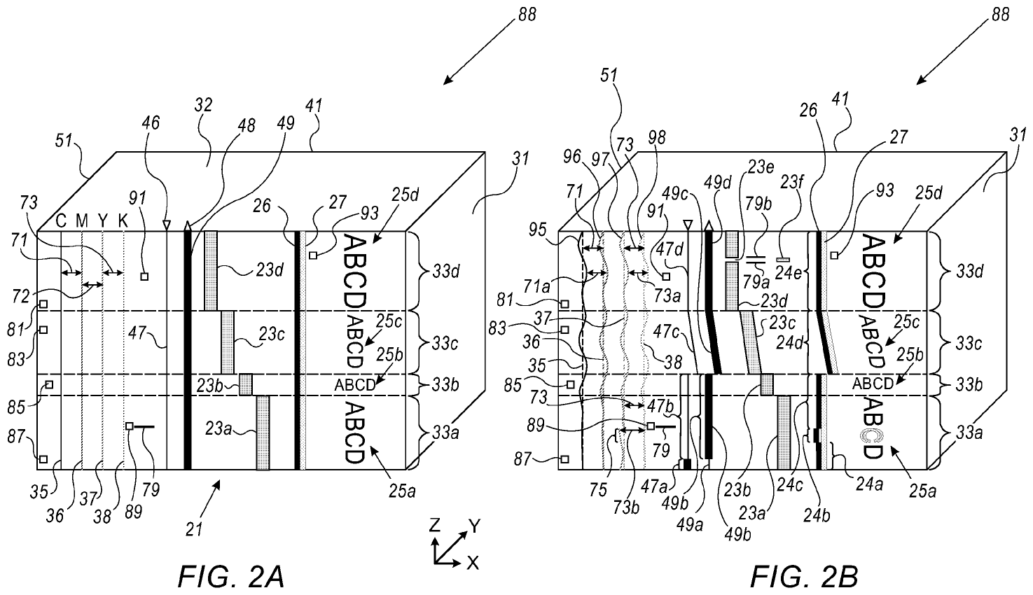

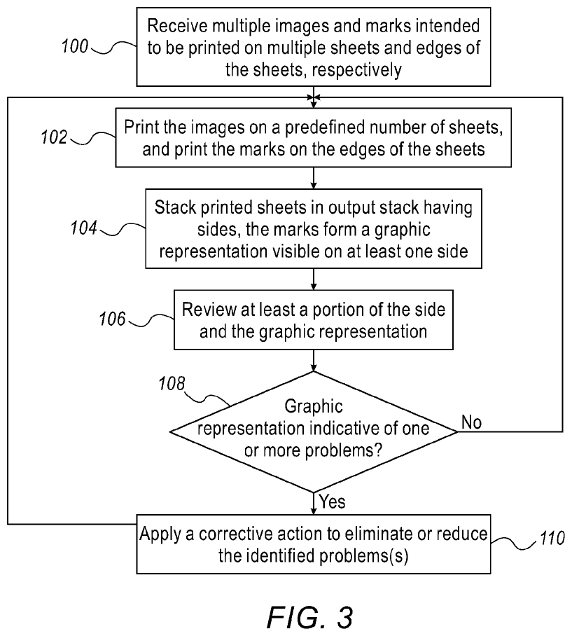

In some embodiments, the identification may be carried out while the system is printing the image and marks on the sheets, also referred to herein on-the-fly (OTF), or after the printing is concluded. In response to identifying a process problem and/or a distortion, the operator and/or processor may perform a corrective action for improving the quality of the images printed by the system. Example embodiments of the process problems, distortions, and corrective actions are described in detail in FIGS. 2A, 2B and 3 below.

The disclosed techniques improve the quality of the images printed by the digital printing system, by early identification of the development of process problems and image distortions. Moreover, the disclosed techniques improve the system productivity by reducing the number of distorted images and increasing the availability of the system for printing qualified images. Furthermore, by reducing the number of distorted images and disqualified sheets, the disclosed techniques reduce the amount of waste (e.g., sheets and fluids related to the printing process) consumed and produced by the system.

### System Description

FIG. 1 is a schematic side view of a digital printing system 10, in accordance with an embodiment of the present invention. In some embodiments, system 10 comprises a rolling flexible blanket 44 that cycles through an image forming station 60, a drying station 64, an impression station 84 and a blanket treatment station 52. In the context of the present invention and in the claims, the terms “blanket” and “intermediate transfer member (ITM)” are used interchangeably and refer to a flexible member comprising one or more layers used as an intermediate member, which is formed in an endless loop configured to receive an ink image, e.g., from image forming station 60, and to transfer the ink image to a target substrate, as will be described in detail below.

In an operative mode, image forming station 60 is configured to form a mirror ink image, also referred to herein as “an ink image” (not shown) or as an “image” for brevity, of a digital image 42 on an upper run of a surface of blanket 44. Subsequently the ink image is transferred to a target substrate, (e.g., a paper, a folding carton, a multilayered polymer, or any suitable flexible package in a form of sheets or continuous web) located under a lower run of blanket 44. In the context of the present invention, the term “run” refers to a length or segment of blanket 44 between any two given rollers over which blanket 44 is guided.

In some embodiments, during installation, blanket 44 may be adhered edge to edge, using a scam section also referred to herein as a scam 45, so as to form a continuous blanket loop, also referred to herein as a closed loop. An example of a method and a system for the installation of the seam is described in detail in U.S. Patent Application Publication 2020/0171813, whose disclosure is incorporated herein by reference.

In some embodiments, image forming station 60 typically comprises multiple print bars 62, each print bar 62 mounted on a frame (not shown) positioned at a fixed height above the surface of the upper run of blanket 44. In some embodiments, each print bar 62 comprises a strip of print heads as wide as the printing area on blanket 44 and comprises individually controllable printing nozzles configured to jet ink and other sort of printing fluids to blanket 44 as described in detail below.

In some embodiments, image forming station 60 may comprise any suitable number of print bars 62, also referred to herein as bars 62, for brevity. Each bar 62 may contain a printing fluid, such as an aqueous ink of a different color. The ink typically has visible colors, such as but not limited to cyan, magenta, red, green, blue, yellow, black, and white. In the example of FIG. 1, image forming station 60 comprises seven print bars 62, but may comprise, for example, four print bars 62 having any selected colors such as cyan (C), magenta (M), yellow (Y) and black (K).

In some embodiments, the print heads are configured to jet ink droplets of the different colors onto the surface of blanket 44 so as to form the ink image (not shown) on the surface of blanket 44. In the present example, blanket 44 is moved along an X-axis of an XYZ coordinate system of system 10, and the ink droplets are directed by the print heads, typically parallel to a Z-axis of the coordinate system.

In some embodiments, different print bars 62 are spaced from one another along the movement axis, also referred to herein as (i) a moving direction 94 of blanket 44 or (ii) a printing direction. In the present example, the moving direction of blanket 44 is parallel to the X-axis, and each print bar 62 is extended along a Y-axis of the XYZ coordinates of system 10. In this configuration, accurate spacing between bars 62 along an X-axis, and synchronization between directing the droplets of the ink of each bar 62 and moving blanket 44 are essential for enabling correct placement of the image pattern.

In the context of the present disclosure and in the claims, the terms “inter-color pattern placement,” “pattern placement accuracy,” “color-to-color registration,” “C2C registration,” and “color registration” are used interchangeably and refer to any placement accuracy of two or more colors relative to one another.

In some embodiments, system 10 comprises heaters 66, such as hot gas or air blowers and/or infrared-based heaters with gas or air blowers for flowing gas or air at any suitable temperature. Heaters 66 are positioned in between print bars 62, and are configured to partially dry the ink droplets deposited on the surface of blanket 44. This air flow between the print bars may assist, for example, (i) in reducing condensation at the surface of the print heads and/or in handling satellites (e.g., residues or small droplets distributed around the main ink droplet), and/or (ii) in preventing clogging of the orifices of the inkjet nozzles of the print heads, and/or (iii) in preventing the droplets of different color inks on blanket 44 from undesirably merging into one another.

In some embodiments, system 10 comprises drying station 64, configured to direct infrared radiation and cooling air (or another gas), and/or to blow hot air (or another gas) onto the surface of blanket 44. In some embodiments, drying station 64 may comprise infrared-based illumination assemblies (not shown) and/or air blowers 68 or any other suitable drying apparatus.

In some embodiments, in drying station 64, the ink image formed on blanket 44 is exposed to radiation and/or to hot air in order to dry the ink more thoroughly, evaporating most or all of the liquid carrier and leaving behind only a layer of resin and coloring agent which is heated to the point of being rendered a tacky ink film.

In some embodiments, system 10 comprises a blanket module 70, also referred to herein as an ITM module, comprising a rolling flexible ITM, such as blanket 44. In some embodiments, blanket module 70 comprises one or more rollers 78, wherein at least one of rollers 78 comprises a motion encoder (not shown), which is configured to record the position of blanket 44, so as to control the position of a section of blanket 44 relative to a respective print bar 62. In some embodiments, one or more motion encoders may be integrated with additional rollers and other moving components of system 10.

In some embodiments, the aforementioned motion encoders typically comprise at least one rotary encoder configured to produce rotary-based position signals indicative of an angular displacement of the respective roller. Note that in the context of the present invention and in the claims, the terms “indicative of” and “indication” are used interchangeably.

Additionally, or alternatively, blanket 44 may comprise an integrated encoder (not shown) for controlling the operation of various modules of system 10. One implementation of the integrated motion encoder is described in detail, for example, in PCT International Publication WO 2020/003088, whose disclosure is incorporated herein by reference.

In some embodiments, blanket 44 is guided in blanket module 70 over rollers 76, 78 and other rollers described herein, and over a powered tensioning roller, also referred to herein as a dancer assembly 74. Dancer assembly 74 is configured to control the length of slack in blanket 44 and its movement is schematically represented in FIG. 1 by a double-sided arrow. Furthermore, any stretching of blanket 44 with aging would not affect the ink image placement performance of system 10 and would merely require the taking up of more slack by tensioning dancer assembly 74.

In some embodiments, dancer assembly 74 may be motorized. The configuration and operation of rollers 76 and 78 are described in further detail, for example, in U.S. Patent Application Publication 2017/0008272 and in the above-mentioned PCT International Publication WO 2013/132424, whose disclosures are all incorporated herein by reference.

In some embodiments, system 10 comprises a blanket tension drive roller (BTD) 99 and a blanket control drive roller (BCD) 77, which are powered by respective first and second motors, typically electric motors (not shown) and are configured to rotate about their own first and second axes, respectively.

In some embodiments, system 10 may comprise one or more tension sensors (not shown) disposed at one or more positions along blanket 44. The tension sensors may be integrated in blanket 44 or may comprise sensors external to blanket 44 using any other suitable technique to acquire signals indicative of the mechanical tension applied to blanket 44. In some embodiments, processor 20 and additional controllers of system 10 are configured to receive the signals produced by the tension sensors, so as to monitor the tension applied to blanket 44 and to control the operation of dancer assembly 74.

In impression station 84, blanket 44 passes between an impression cylinder 82 and a pressure cylinder 90, which is configured to carry a compressible blanket. In some embodiments, a motion encoder is integrated with at least one of impression cylinder 82 and pressure cylinder 90.

In some embodiments, system 10 comprises a control console 12, which is configured to control multiple modules of system 10, such as blanket module 70, image forming station 60 located above blanket module 70, and a substrate transport module 80, which is located below blanket module 70 and comprises one or more impression stations as will be described below.

In some embodiments, console 12 comprises a processor 20, typically a general-purpose processor, with suitable front end and interface circuits for interfacing with controllers of dancer assembly 74 and with a controller 54, via a cable 57, and for receiving signals therefrom. Additionally, or alternatively, console 12 may comprise any suitable type of an application-specific integrated circuit (ASIC) and/or a digital signal processor (DSP) and/or any other suitable sort of processing unit configured to carry out any sort of processing for data processed in system 10.

In some embodiments, controller 54, which is schematically shown as a single device, may comprise one or more electronic modules mounted on system 10 at predefined locations. At least one of the electronic modules of controller 54 may comprise an electronic device, such as control circuitry or a processor (not shown), which is configured to control various modules and stations of system 10. In some embodiments, processor 20 and the control circuitry may be programmed in software to carry out the functions that are used by the printing system, and store data for the software in a memory 22. The software may be downloaded to processor 20 and to the control circuitry in electronic form, over a network, for example, or it may be provided on non-transitory tangible media, such as optical, magnetic or electronic memory media.

In some embodiments, console 12 comprises a display 34, which is configured to display data and images received from processor 20, or inputs inserted by a user (not shown) using input devices 40. In some embodiments, console 12 may have any other suitable configuration, for example, an alternative configuration of console 12 and display 34 is described in detail in U.S. Pat. No. 9,229,664, whose disclosure is incorporated herein by reference.

In some embodiments, processor 20 is configured to display on display 34, a digital image 42 comprising one or more segments (not shown) of image 42 and/or various types of test patterns that may be stored in memory 22.

In some embodiments, blanket treatment station 52, also referred to herein as a cooling station, is configured to treat the blanket by, for example, cooling it and/or applying a treatment fluid to the outer surface of blanket 44, and/or cleaning the outer surface of blanket 44. At blanket treatment station 52, the temperature of blanket 44 can be reduced to a desired temperature-level before blanket 44 enters (e.g., being placed in closed proximity with) image forming station 60. The treatment may be carried out by passing blanket 44 over one or more rollers or blades configured for applying cooling and/or cleaning and/or treatment fluid to the outer surface of the blanket.

In some embodiments, blanket treatment station 52 may further comprise one or more bars (not shown) positioned adjacent to print bars 62, so that the treatment fluid may additionally or alternatively be applied to blanket 44 by jetting.

In some embodiments, processor 20 is configured to receive, e.g., from temperature sensors (not shown), signals indicative of the surface temperature of blanket 44, so as to monitor the temperature of blanket 44 and to control the operation of blanket treatment station 52. Examples of such treatment stations are described, for example, in PCT International Publications WO 2013/132424 and WO 2017/208152, whose disclosures are all incorporated herein by reference.

In the example of FIG. 1, station 52 is mounted between impression station 84 and image forming station 60, yet station 52 may be mounted adjacent to blanket 44 at any other or additional one or more suitable locations between impression station 84 and image forming station 60. As described above, station 52 may additionally or alternatively be mounted on a bar adjacent to image forming station 60.

In the example of FIG. 1, impression cylinder 82 and pressure cylinder 90 impress the ink image onto the target flexible substrate, such as an individual sheet 50, conveyed by substrate transport module 80 from an input stack 86 to an output stack 88 via impression station 84. In the present example, a rotary encoder (not shown) is integrated with impression cylinder 82.

In some embodiments, the lower run of blanket 44 selectively interacts at impression station 84 with impression cylinder 82 to impress the image pattern onto the target flexible substrate compressed between blanket 44 and impression cylinder 82 by the action of pressure of pressure cylinder 90. In the case of a simplex printer (i.e., printing on one side of sheet 50) shown in FIG. 1, only one impression station 84 is needed.

In other embodiments, module 80 may comprise two or more impression cylinders (not shown) so as to permit one or more duplex printing. The configuration of two impression cylinders also enables conducting single sided prints at twice the speed of printing double sided prints. In addition, mixed lots of single-sided and double-sided prints can also be printed. In alternative embodiments, a different configuration of module 80 may be used for printing on a continuous web substrate. Detailed descriptions and various configurations of duplex printing systems and of systems for printing on continuous web substrates are provided, for example, in U.S. Pat. Nos. 9,914,316 and 9,186,884, in PCT International Publication WO 2013/132424, in U.S. Patent Application Publication 2015/0054865, and in U.S. Provisional Application 62/596,926, whose disclosures are all incorporated herein by reference.

In some embodiments, sheets 50 or continuous web substrate (not shown) are carried by module 80 from input stack 86 and pass through the nip (not shown) located between impression cylinder 82 and pressure cylinder 90. Within the nip, the surface of blanket 44 carrying the ink image is pressed firmly, e.g., by the compressible blanket of pressure cylinder 90, against sheet 50 (or against another suitable substrate) so that the ink image is impressed onto the surface of sheet 50 and separated neatly from the surface of blanket 44.

In some embodiments, system 10 comprises a stacking assembly 59, which is configured to receive sheets 50 that are transported by module 80 and to arrange sheets 50 in output stack 88. In some embodiments, stacking assembly 59 is configured to stack sheets 50 on top of one another to form output stack 88 having a top surface 32, which is typically parallel to sheets 50. Output stack 88 has sides (shown and described in detail in FIGS. 2A and 2B below) that are made from the stacked edges of sheets 50, and are typically (but not necessarily) orthogonal to top surface 32.

In other embodiments, system 10 may comprise any other suitable type of stacking assembly, which is configured to stack the aforementioned continuous web substrate (or any other suitable type of substrate) using any suitable stacking configuration.

In the example of FIG. 1, rollers 78 are positioned at the upper run of blanket 44 and are configured to maintain blanket 44 taut when passing adjacent to image forming station 60. Furthermore, it is particularly important to control the speed of blanket 44 below image forming station 60 so as to obtain accurate jetting and deposition of the ink droplets to form an image, by image forming station 60, on the surface of blanket 44.

In some embodiments, impression cylinder 82 is periodically engaged with and disengaged from blanket 44, so as to transfer the ink images from moving blanket 44 to the target substrate passing between blanket 44 and impression cylinder 82. In some embodiments, system 10 is configured to apply torque to blanket 44 using the aforementioned rollers and dancer assemblies, so as to maintain the upper run taut and to substantially isolate the upper run of blanket 44 from being affected by mechanical vibrations occurring in the lower run.

In some embodiments, system 10 comprises an image quality control station 55, also referred to herein as an automatic quality management (AQM) system, which serves as a closed loop inspection system integrated in system 10. In some embodiments, image quality control station 55 may be positioned adjacent to impression cylinder 82, as shown in FIG. 1, or at any other suitable location in system 10.

In some embodiments, image quality control station 55 comprises a camera (not shown), which is configured to acquire one or more digital images of the aforementioned ink image printed on sheet 50. In some embodiments, the camera may comprise any suitable image sensor, such as a Contact Image Sensor (CIS) or a Complementary metal oxide semiconductor (CMOS) image sensor, and a scanner comprising a slit having a width of about one meter or any other suitable width.

In the context of the present disclosure and in the claims, the terms “about” or “approximately” for any numerical values or ranges indicate a suitable dimensional tolerance that allows the part or collection of components to function for its intended purpose as described herein.

In some embodiments, the digital images acquired by station 55 are transmitted to a processor, such as processor 20 or any other processor of station 55, which is configured to assess the quality of the respective printed images. Based on the assessment and signals received from controller 54, processor 20 is configured to control the operation of the modules and stations of system 10. In the context of the present invention and in the claims, the term “processor” refers to any processing unit, such as processor 20 or any other processor or controller connected to or integrated with station 55, which is configured to process signals received from the camera and/or the spectrophotometer of station 55. Note that the signal processing operations, control-related instructions, and other computational operations described herein may be carried out by a single processor, or shared between multiple processors of one or more respective computers.

In some embodiments, station 55 is configured to inspect the quality of the printed images and test pattern so as to monitor various attributes, such as but not limited to full image registration with sheet 50, also referred to herein as image-to-substrate registration, color-to-color (C2C) registration, printed geometry, image uniformity, profile and linearity of colors, and functionality of the print nozzles. In some embodiments, processor 20 is configured to automatically detect geometrical distortions or other errors in one or more of the aforementioned attributes. In the context of the present disclosure and in the claims, the terms “detect” and “identify” are used interchangeably and refer to finding a defect and/or a distortion in the printed image, and/or finding a process problem that occurs in the digital printing system.

In some embodiments, processor 20 is configured to analyze the detected distortion in order to apply a corrective action to the malfunctioning module, and/or to feed instructions to another module or station of system 10, so as to compensate for the detected distortion.

In some embodiments, system 10 is configured to print testing marks (shown in detail in FIGS. 2A and 2B below) or other suitable features, for example at the bevels or margins of sheet 50. By acquiring images of the testing marks, station 55 is configured to measure various types of distortions, such as C2C registration, image-to-substrate registration, different width between colors referred to herein as “bar to bar width delta” or as “color to color width difference”, various types of local distortions, and front-to-back registration errors (in duplex printing). In some embodiments, processor 20 is configured to: (i) sort out, e.g., to a rejection tray (not shown), sheets 50 having a distortion above a first predefined set of thresholds, (ii) initiate corrective actions for sheets 50 having a distortion above a second, lower, predefined set of thresholds, and (iii) output sheets 50 having minor distortions, e.g., below the second set of thresholds, to output stack 88.

In the context of the present disclosure and in the claims, the term “image-to-substrate registration error” refers to an offset between the intended and the actual position of the printed image on the sheet. The offset may be caused, inter alia, by unintended movement of the image relative to the intended position on sheet 50. The unintended movement may occur due to one or both of: (i) movement of the image, e.g., in XY plain of the XYZ coordinate system, relative to the intended position on sheet 50, before printing the image on sheet 50. This movement is also referred to herein as “translation,” and (ii) unintended rotation of sheet 50, e.g., about the Z-axis of the XYZ coordinate system, which is orthogonal to the XY plain, before printing the image thereon.

In some embodiments, processor 20 is configured to detect, based on signals received from the spectrophotometer of station 55, deviations in the profile and linearity of the printed colors.

In some embodiments, the processor of station 55 is configured to decide whether to stop the operation of system 10, for example, in case the density of distortions is above a specified threshold. The processor of station 55 is further configured to initiate a corrective action in one or more of the modules and stations of system 10, as described above. In some embodiments, the corrective action may be carried out on-the-fly (while system 10 continues the printing process), or offline, by stopping the printing operation and fixing the problem in respective modules and/or stations of system 10. In other embodiments, any other processor or controller of system 10 (e.g., processor 20 or controller 54) is configured to start a corrective action or to stop the operation of system 10 in case the density of distortions is above a specified threshold.

Additionally, or alternatively, processor 20 is configured to receive, e.g., from station 55, signals indicative of additional types of distortions and problems in the printing process of system 10. Based on these signals, processor 20 is configured to automatically estimate the level of pattern placement accuracy and additional types of distortions and/or defects not mentioned above. In other embodiments, any other suitable method for examining the pattern printed on sheets 50 (or on any other substrate described above) can also be used, for example, using an external (e.g., offline) inspection system, or any type of measurements jig and/or scanner. In these embodiments, based on information received from the external inspection system, processor 20 is configured to initiate any suitable corrective action and/or to stop the operation of system 10.

In some embodiments, a combination of image forming station 60, drying station 64, blanket module 70, substrate transport module 80 and one or more impression stations 84, is also referred to herein as a printing assembly 13, which is configured to print the images on sheets 50 and the aforementioned marks on one or more edges of the respective sheets 50, as will be described in detail in FIGS. 2A and 2B below.

The configuration of system 10 is simplified and provided purely by way of example for the sake of clarifying the present invention. The components, modules and stations described in printing system 10 hereinabove and additional components and configurations are described in detail, for example, in U.S. Pat. Nos. 9,327,496 and 9,186,884, in PCT International Publications WO 2013/132438, WO 2013/132424 and WO 2017/208152, in U.S. Patent Application Publications 2015/0118503 and 2017/0008272, whose disclosures are all incorporated herein by reference.

The particular configuration of system 10 is shown by way of example, in order to illustrate certain problems that are addressed by embodiments of the present invention and to demonstrate the application of these embodiments in enhancing the performance of such systems. Embodiments of the present invention, however, are by no means limited to this specific sort of example systems, and the principles described herein may similarly be applied to any other sorts of printing systems.

Printing on Edges of Sheets Marks Indicative of a Problem Occurring while Printing Images

FIG. 2A is a schematic side view of output stack 88 having several marks printed on an side 21 of one or more sheets 50, in accordance with an embodiment of the present invention.

In some embodiments, each sheet 50 has a surface, which is configured to receive the image from blanket 44, the surface is typically parallel to top surface 32 of output stack 88. As also described in FIG. 1 above, while printing in system 20, a section of blanket 44 and one sheet 50 are placed at the same time between impression cylinder 82 and pressure cylinder 90, which are engaged with one another so as to transfer the ink image from blanket 44 onto the surface of sheet 50. In the present example, each sheet 50 has a rectangular shape and comprises four edges that are typically orthogonal to the surface that receives the image from blanket 44. In the XYZ coordinated system of FIGS. 2A and 2B, the surface that receives the image is typically parallel to the XY plane, and the edges of each sheet 50 are indicative of the sheet thickness along the Z-axis of the XYZ coordinated system.

In some embodiments, after transferring the images to the respective surfaces, sheets 50 are stacked on top of one another along the Z-axis of output stack 88. In the present example, output stack 88 has four sides 21, 31, 41, and 51 produced by stacking the four respective edges of the stacked sheets 50. Sides 21, 31, 41, and 51 are visible in a side-view of output stack 88, and the thicknesses of sides 21, 31, 41 and 51 is measured along the Z-axis and typically equals to the sum of the thickness of all the sheets 50 stacked in output stack 88.

In the context of the present disclosure and in the claims, the term “side view” is obtained when the gaze of an operator and/or a camera (not shown) of system 10 is directed to one or more of sides 21, 31, 41, and 51. The camera is configured to acquire a side-wall image of the respective side (e.g., side 21) of output stack 88. In the present example, the marks that are described in detail herein are shown only on side 21, which is typically parallel to XZ plane of the XYZ coordinate system. In some cases, on or more of sheets 50 may not be aligned with the other sheets of output stack 88. In other words, there may be a misalignment between at least two sheets 50 of output stack 88. Thus, the corresponding edge of the respective sheet 50 may not be within the same XZ plane, but in the side view, the edge is visible along the Z-axis of the XYZ coordinate system. In some embodiments, based on the side-wall image, processor 20 is configured to detect the misalignment between at least two of sheets 50 that are stacked on top of one another in output stack 88. Additionally, or alternatively, any suitable combination of marks may be printed on one or more edges of sheets 50, and may be visible in the side view of one or more of sides 31, 41, and 51 of output stack 88. For example, marks may be printed on another edge of sheets 50, which is orthogonal to the edge corresponding to side 21. In this example, the printed marks may be visible in a side view of side 31, which is typically parallel to the YZ plane of the XYZ coordinate system.

In some embodiments, processor 20 receives an image from a user of system 10 or from a client having product images for printing. The image may be in a form of: (i) a page description in a high-level page description language (PDL), such as PostScript (PS), Portable Document Format (PDF), or any other suitable format of high-level PDL, or (ii) a vector image, or any other suitable format of an image intended to be printed using system 10.

In some embodiments, based on the received image, processor 20 is configured to produce a digital image, such as image 42 shown in FIG. 1 above, which has a suitable format and is intended to be printed using the features of system 10 described in FIG. 1 above. In essence, (i) image forming station 60 applies droplets of ink to the surface of moved blanket 44, so as to form an image of ink thereon, (ii) the image is transferred to sheet 50 that is received from input stack 86, and (iii) after transferring the image to sheet 50, substrate transport module 80 transfers sheet 50, having the image printed thereon, to output stack 88.

In some embodiments, processor 20 is configured to determine various types of marks that are intended to be printed on the edges of one or more sheets 50. In the present example, the marks that are visible in the side-view of side 21, may be indicative of one or more problems occurred while printing one or more of the images on respective sheets 50 that are stacked in output stack 88.

In some embodiments, the marks that are visible on side 21 may also be indicative of one or more malfunctions that may have been occurred in system 10 while processing sheets 50.

Note that in the present example, the disclosed techniques are typically related to printing marks on one or more edges of sheets 50 using, inter alia, blanket 44 or any other suitable type of ITM. However, the disclosed techniques may be used, mutatis mutandis, in other applications, such as but not limited to, in: (i) printing marks on the edge of a continuous web (instead of sheet 50), and (ii) directly printing on a target substrate, such as sheet 50, using image forming station or any other suitable type of ink jetting technique. The term “directly printing” refers to jetting the printing fluid (e.g., droplets of ink) directly on sheet 50, without using blanket 44 or any other sort of ITM.

Additionally, or alternatively, system 10 may comprise an edge printing apparatus (not shown), which is configured to print the marks on side 21 while one or more sheets 50 are processed in system 10.

In some embodiments, system 10 is configured to print the marks on side 21 while printing image 42, and the marks printed on side 21 are visible on a side view of output stack 88.

In some embodiments, when sheets 50 are stacked on top of one another in output stack 88, the marks that are visible in the corresponding side view, jointly form a pattern having a graphic representation of a problem that occurred while printing the images. The problems may cause distortion that appears as a function of the locations of the respective sheets 50 piled within output stack 88.

In some embodiments, the marks printed on the edges of sheets 50 and visible in the side view of side 21, may be used by an operator (not shown) of system 10 for monitoring the health of the printing process by looking at the marks shown on side 21 (and other sides) of output stack 88. Additionally, or alternatively, processor 20 is configured to receive a side-view image of the marks visible in the side view of side 21 of output stack 88, and based on the side-view image, processor 20 is configured to analyze the printed marks and to detect: (i) one or more distortions in one or more of the printed images, and/or (ii) malfunctioning of one or more modules of system 10, and/or (iii) an operational problem, such as selection of a wrong printing job, as shown in FIG. 2B below.

In other embodiments, processor 20 is configured to analyze all the marks that appear in the side-view image, or some of the marks shown in one or more sections of the side-view image of side 21. In yet other embodiments, the side-view image may only a portion of side 21, and processor 20 may analyze all the marks in the portion, or only a predefined set of the marks shown in the side-view image.

In the present example, image 42 comprises four color images, such as cyan (C), magenta (M), yellow (Y) and black (K) (CMYK) images, which are combined in the printed version of image 42. In other examples, image 42 may comprise any other suitable number of color images, e.g., seven or eight color images (e.g., cyan, magenta, red, green, blue, yellow, black, and white), which are combined in image 42. The techniques described below is related to the CMYK images, but the same techniques may be applied to an image comprising any suitable number of color images. In the context of the present disclosure and in the claims, the terms color and colour are used interchangeably.

In some embodiments, processor 20 is configured to determine marks 35, 36, 37 and 38 that are intended to be printed by system 10 on the edge of sheets 50 that corresponds to side 21. In the present example, marks 35, 36, 37 and 38 are associated with the C, M, Y and K color images, respectively. Marks 35-38 are indicative of the position of each color image, also referred to herein as “color positions,” and are typically printed while printing the respective color images. The shape of a graphic representation of the marks in the side view of side 21 is indicative of whether or not there is a distortion in the respective color image. For example, mark 35 is printed on the edge of sheets 50 (and is shown in the side view of side 21), while the cyan image of image 42 is printed on sheet 50, and the graphic representation of the side view of marks 35 is indicative of whether or not there is a distortion in the printed cyan image.

In an embodiment, at least one of and typically all marks 35, 36, 37 and 38 may individually or jointly form one or more graphic representation(s) of the distortion(s) as a function of locations of the respective one or more-color images in each of the images that are printed on sheets 50 stacked in output stack 88.

In some embodiments, the shape, the position of marks 35-38, and the distance between marks 35-38 are selected for monitoring various types of problems that may have occurred while printing the images on sheets 50. The position of marks 35-38 may be indicative of one or more registration errors caused by the problems. For example, an image-to-substrate registration error and a C2C registration error. In the example of FIG. 2A, none of the images that have been printed on sheets 50 has a distortion or any indication of a problem, such as a problem in the printing process and/or a system malfunction occurred during the printing process. In such embodiments, marks 35 and 36 are determined at a distance 71 from one another, similarly, marks 36 and 37 are determined at a distance 72 from one another, and marks 37 and 38 are determined at a distance 73 from one another. In an embodiment, distances 71-73 may be similar (i.e., distance 71 equals to distance 72 and to distance 73), or one or more of distances 71-73 may differ from one or more of the other distances.

In some embodiments, in the absence of the image-to-substrate and the C2C registration errors, marks 35-38 appear as straight lines in the side-view of side 21. The appearance of marks 35-38 in the presence of distortions and/or registration errors, such as image-to-substrate registration error and C2C registration error, is shown in FIG. 2B below.

In some embodiments, after determining the marks, system 10 is configured to print the images and the marks simultaneously on at least one of sheets 50. As described above, the image is printed on the substrate, so that while printing the image on a given sheet 50, system 10 is configured to print the marks (such as marks 35-38 and additional marks described below) on given sheet 50 at the same time. In the present example, the simultaneous printing of the image and the marks is applied to all sheets 50, and more specifically, to sheets 50 that are intended to receive the product images.

In some cases, one or more non-product sheets, such as service sheets 50, are printed in system 10, e.g., for testing, calibration and other maintenance operations. In some embodiments, processor 20 is configured to determine one or more marks, such as a mark 79, which is indicative of such non-product printed sheets 50. Such non-product sheets 50 are sorted out of the stack of product sheets 50 having the printed product, e.g., of image 42. In some embodiments, mark 79 may have a different color than that of the sheets 50 having product images. For example, the edge of the sheets 50 having product images may have a black color or a white color, whereas mark 79 may have a magenta color.

In some embodiments, processor 20 is configured to determine marks 46 and 48 intended to be printed on sheet 50, and marks 47 and 49 that are intended to be printed by system 10 on the edge of sheets 50, so that marks 47 and 49 are visible in the side view of side 21. Each of marks 46 and 48 has a triangular shape, so as to print marks 47 and 49 in a predefined size (e.g., width) along the X-axis of the XYZ coordinate system. For example, when printing mark 46, the end of the triangle apex forms a thin mark 47 on the edge of sheets 50 and is shown in the side view of side 21, and similarly, when printing mark 48 on the edge of sheets 50, the end of the triangle base forms mark 49, which appears wider than mark 47 along the X-axis in the side view of side 21. Moreover, the different position between marks 47 and 49 along the X-axis of the edge of sheet 50 may be indicative of the orientation of sheet 50.

In some embodiments, marks 47 and 49 that have a triangle shape, may be indicative of the orientation of sheet 50 in output stack 88, and therefore, a side-view image of the graphic representation of marks 47 and 49 is also referred to herein as an orientational graphic representation, which is indicative of an orientation of each sheet 50 having a printed image and marks 47 and/or 49 in output stack 88. For example, in a duplex printing on both sides of sheet 50, one or more of sheets 50 may be printed by mistake on one side only, and at least some of the misprocessed sheets 50 may be positioned in a flipped position in output stack 88.

In some embodiments, processor 20 receives a first image intended to be printed on a first side of each sheet 50, and a second image intended to be printed on a second side, which is opposite the first side of each sheet 50. Processor 20 is configured to determine: (i) marks 46 and 47 on sheet 50 and on the edge of sheet 50 corresponding to side 21, respectively, and (ii) marks 48 and 49 on sheet 50 and on the edge of sheet 50 corresponding to side 41, respectively. In such embodiments, flipping or skew of one or more sheets 50 may be immediately identified by a user of system 10 and/or by processor 20 that receives the side-view image of side 21. Thus, marks 47 and 49 are indicative of any undesired skew or flip of one or more sheets 50. An example of such malfunctions is shown in FIG. 2B below.

In some embodiments, processor 20 is configured to determine marks 23a, 23b, 23c and 23d that are intended to be printed by system 10 on the edge of sheets 50 that corresponds to side 21 of output stack 88. In the present example, marks 23a, 23b, 23c and 23d are indicative of printing jobs 33a, 33b, 33c and 33d carried out, respectively, in system 10. Note that marks 23a, 23b, 23c and 23d may be indicative of a process problem, such as a distortion in the image printed on sheet 50, and/or a processing malfunction related to one or more sheets 50 in output stack 88. An example of such indications of process problems is shown in FIG. 2B below.

In some embodiments, processor 20 is configured to determine one or more marks comprising one or more machine-readable labels (MRLs), respectively. The MRLs may comprise any suitable type of readable labels, such as but not limited to: (i) one or more machine-readable optical labels, and (ii) one or more machine-readable magnetic labels. The MRLs may contain suitable information described in detail below.

In an embodiment, the user of system 10 may use a smartphone for reading the information and/or any suitable type of optical or magnetic reader or scanner for reading the information stored in the MRLs. Additionally, or alternatively, system 10 may comprise one or more suitable optical or magnetic readers or scanners configured to produce a signal indicative of the information stored in the MRLs. Based on the signal, processor 20 is configured to display the information to the user (e.g., on display 34), and if needed, to control system 10 to take a corrective action, as will be described below.

In some embodiments, the MRLs may have (i) a two-dimensional (2D) shape, such as but not limited to a quick response (QR) code, or an AZTEC code, or (ii) a one-dimensional (1D) shape, such as a barcode.

In some embodiments, the MRLs may contain information about at least one of: (i) one or more properties of at least one of the substrates (e.g., size, thickness, and materials), (ii) one or more properties of at least one of the images (e.g., number and color of ink used for producing the images, the resolution and size of the images), and (iii) one or more administrative properties of at least a portion of output stack 88. The administrative information may comprise at least one of: the intended number of sheets 50, and the client of the respective portion of stack 88. In the present example, processor 20 is configured to determine marks 81, 83, 85 and 87, which are MRLs comprising the one or more properties of the substrates and/or images and/or administration of the stacks of printing jobs 33d, 33c, 33b and 33a, respectively.

In some embodiments, the information stored in the MRLs may comprise one or more properties of at least one of the marks, and the problem intended to be detected by the respective marks. In one example implementation, processor 20 is configured to determine a mark 91, which is related to marks 35-38, and to distances 71-73. In an embodiment, mark 91 may comprise control limits indicative of the specified level of each of distances 71-73. For example, the control limits of distance 71 are between about 1 cm and 1.1 cm, so that in response to receiving a measured distance 71 of about 1.05 cm, the information stored in mark 91 provides the user with an indication that the C2C registration between the cyan and magenta colors is within the specification. In case the measured distance 71 is larger than about 1.1 mm or smaller than about 1 mm, the user can immediately receive an alarm indicative of a problem in the C2C registration between the cyan and magenta colors. Examples of C2C and image-to-substrate registration errors are shown and described in detail in FIG. 2B below.

In some embodiments, processor 20 is configured to determine a mark 89, which is an MRL positioned in close proximity to mark 79, and provides the user with information about the testing, calibration or other maintenance operations carried out while printing the one or more non-product images on the one or more respective sheet(s) 50 having mark 79. In some embodiments, processor 20 is configured to determine marks 26 and 27 that are intended to be printed by system 10 on the edge of sheets 50 that corresponds to side 21. In the present example, marks 26 and 27 and the relative position (e.g., vectorial distance) therebetween are indicative of a C2C registration error between two or more color images of the printed version of image 42. For example, in response to a shift or offset between two color images, or between a selected section of the color images, the position of at least one of marks 26 and 27 may alter (as will be shown in FIG. 2B below) for indicating the C2C registration error.

In another example implementation, processor 20 is configured to determine a mark 93, which is an MRL positioned in close proximity to marks 26 and 27. In this embodiment, mark 93 is indicative of control limits of C2C registration error between two or more color images of the printed version of image 42. As described in the example of mark 91, by reading the information stored in mark 93, the user can compare between the calculated and the control limits of the C2C registration error, and can infer of whether the measured C2C registration error is within the specification of printing job 33d.

In some embodiments, processor 20 is configured to determine marks 25a, 25b, 25c and 25d that are intended to be printed by system 10 on the edge of sheets 50 that corresponds to side 21. In the present example, marks 25a, 25b, 25c and 25d are indicative of various types of problems that occurred while printing the images on one or more sheets 50. Example indications are shown in FIG. 2B below. Moreover, marks 25a, 25b, 25c and 25d may be used in other applications, such as in distinguishing between clients of system 10, or in printing of a product, such as a dictionary.

The marks described above are provided by way of example for the sake of conceptual clarity. In other embodiments, one or more of these marks may have a different, size, shape, position, color, or any other suitable attribute that is indicative of a process problem and/or a distortion in one or more images printed on one or more sheets 50. Moreover, at least one of these marks may be determined on and applied to other edges of output stack 88, in addition to, or instead of, the marks shown on side 21.

FIG. 2B is a schematic side view of output stack 88 of sheets 50 having several marks printed on the edge of sheets 50 that corresponds to side 21, in accordance with an embodiment of the present invention.

In some embodiments, the intended position of marks 35, 36, 37 and 38 (in the absence of distortions, as shown in FIG. 2A above) is shown in broken lines, and the actual appearance thereof is shown in marks 95, 96, 97 and 98, respectively. In the present example, distance 71a between marks 95 and 96 is substantially identical to distance 71 between marks 35 and 36. In such embodiments. (i) the difference between the positions of marks of each color (e.g., marks 35 and 95), and (ii) the substantially identical distance between the marks of the pair of colors (e.g., distances 71 and 71a), is indicative of: (i) an image-to-substrate registration error in some of the images printed on respective sheets 50, and (ii) no C2C registration error between the color images comprising each printed image 42.

In the example of marks 97 and 98, distance 73a between marks 97 and 98 is substantially identical to distance 73 between marks 37 and 38, however, in a section 75, distance 73b is different (e.g., larger) than distance 73. In such embodiments, in printing jobs 33b, 33c and 33d (i) the difference between the position of the marks of each color (e.g., marks 38 and 98), and (ii) the substantially identical distance between the marks of the pair of colors (e.g., distances 73 and 73a), is indicative of: (i) an image-to-substrate registration error in some of the images printed on respective sheets 50, and (ii) no C2C registration error between the color images comprising each printed image 42. In section 75 of printing job 33a, however, (i) the position of marks 37 and 97 are different, and (ii) distance 73b is different from (e.g., larger than) distance 73. Thus, marks 97 and 98 are indicative of both image-to-substrate and C2C registration errors in the printed version of image 42 on sheets 50 that are in section 75 of output stack 88.

In the example of FIG. 2B, during the process of printing job 33a a C2C registration error started to develop while printing sheets 50 of section 75. In some embodiments, based on the difference between distances 73b and 73, processor 20 and/or the operator of system 10 have detected a C2C registration error, which may exceed the process specification of printing job 33a in system 10. In response to detecting the suspected C2C registration error, the operator stops printing job 33a and controls system 10 to carry out one or more testing and calibration printing on non-product sheets, which have mark 79 described in FIG. 2A above. In some embodiments, system 10 is calibrated for correcting a registration problem in the yellow image of image 42, which is indicated by mark 97. Subsequently, the operator controls system 10 to resume printing job 33a, in which the position of mark 97 and the distances between mark 97 and marks 96 and 98 are within the specification of printing job 33a, as indicated by the graphic representation of marks 95-98 printed on the edge of sheets 50 that corresponds to side 21.

In some embodiments, in a section 47a of printing job 33a, mark 47 is indicative of flipping of one or more sheets 50, e.g., while performing a duplex printing as described in FIGS. 1 and 2A above. Similarly, in a section 49a of printing job 33a, mark 49 that may be printed (additionally, or alternatively) on the edge of sheets 50 that corresponds to side 41, is indicative of the flipping of one or more sheets 50.

In some embodiments, in response to detecting the flipping, processor 20 and/or the operator stops the operation of system 10, corrects the problem causing the flipping, and resumes printing job 33a. As shown in sections 47b and 49b of printing jobs 33a and 33b, after resuming the process, no flipped page has been transferred to output stack 88 in printing jobs 33a and 33b. Moreover, as shown in sections 49b and 49d, and in sections 47b and 47d, marks 47 and 49 are indicative of correct orientation and no flipping of sheets 50 in output stack 88.

In some embodiments, in sections 47c and 49c of printing job 33c, marks 47 and 49 are indicative of a skew error of the printed image caused by some rotation of sheets 50 about the Z-axis of the XYZ coordinate system. In the example of FIG. 2B, the sheet-rotation and image skew error are graphically represented by the tilted lines, which are indicative of an offset and drifting in the position of marks 47 and 49.

In some embodiments, processor 20 is configured to control system 20 to print mixed lots and/or printing jobs of single-sided (i.e., simplex printing) and double-sided prints (i.e., duplex printing), as described in FIG. 1 above. In some embodiments, processor 20 is configured to determine the position, the shape, and the size of marks 46-49 for being indicative of whether or not a process problem has been occurred in such mixed lots. For example, the configuration of sections 47a and/or 49a may be indicative of a duplex printing, and the configuration of sections 47d and/or 49d may be indicative of a simplex printing.

In some embodiments, marks 23c and 25c are tilted, and section 24d of marks 26 and 27 and is also tilted, all these graphic representations of shifted marks and/or tilted patterns are indicative of the skew in the position of printed image 42 relative to respective sheets 50, which is caused by the rotation of sheets 50 about the Z-axis as described above. Note that in the example of mark 25c, the graphic representation of the text (e.g., the ABCD letters) appears tilted in the side view of side 21.

In some embodiments, mark 23d is indicative of an error in the operation of system 10. In the present example, during printing job 33c, the operator stopped the production and carried out testing and/or calibration printing on some non-product sheets 50, which is indicated by the appearance of a mark 79a. Subsequently, the operator selected, by mistake, a recipe for applying to sheets 50 printing job 33a rather than printing job 33d.

In some embodiments, a mark 23e (that corresponds to printing job 33a) is printed on the edge of sheets 50 that corresponds to side 21 and causes an opening 23e in the graphic representation of mark 23d shown on side 21. In response to detecting the operational error, processor 20 and/or the operator stops the operation of system 10, carries out an additional calibration operation shown by a mark 79b printed on one or more sheets 50, selects the correct recipe, and resumes printing job 33d.

In such embodiments, sheets 50 having a mark 23f may be added to the stack of printing job 33a, and if needed, the recipe of printing job 33d may be applied to additional sheets 50 for filling the missing sheets 50 indicated by opening 23e in the graphic representation of mark 23d on side 21. Note that in this embodiment, marks 23d and 23f are used for saving a waste of sheets 50 and printing fluids that may have otherwise be trashed.

In some embodiments, marks 26 and 27 that are determined by processor 20 as described in FIG. 2A above, may be indicated of a C2C registration. In the present example, a section 24b of printing job 33a is indicative of the registration error in the yellow image in the printed sheets 50 of section 24b. Note that the graphic representation of the distance between marks 26 and 27 is indicative of the C2C registration and is not depending on other distortions and printing process problems, such as the image-to-substrate registration and/or the image skew described above. For example, in sections 24a, 24c, 24d and 24e the C2C registration is within the process specification of the respective printing jobs, and the other distortions that are described above, are not affecting the position of marks 26 and 27 relative to one another.

In some embodiments, the shape of the letter “C” of mark 25a is also indicative of the C2C registration error caused by the registration error in the yellow image of image 42 that is printed in sheets 50 that are stacked in section 24b.

In alternative embodiments, the letters that graphically represent the position of marks 25a-25d, may be used for indicating other problems in the printing process carried out in system 10. For example, processor 20 may determine the position of these marks such that a local shift in the graphic representation of one or more letter (or in a section thereof), is indicative of an image-to-substrate registration error (resulting, for example, in a blurred or distorted letter or a section thereof), and a skew that appears as a tilted word formed by the letters of the mark, as shown for example in the position of the letters of mark 25c.

These particular configurations of the marks shown in FIGS. 2A and 2B above are shown and described by way of example, in order to illustrate certain problems, such as detection of process problems, distortions in images, equipment failure and operational errors, which are addressed by embodiments of the present invention and to demonstrate the application of these embodiments in enhancing the performance of such a digital printing system. Embodiments of the present invention, however, are by no means limited to this specific sort of example problems and marks, and the principles described herein may similarly be applied to other sorts of problems and distortions in images printing using system 10 or in other printing systems that are applying direct printing or printing using any suitable type of one or more intermediate transfer components of various configurations of printing systems that are known in the art. Moreover, the size, shape, position, color, and other attributes of the marks may be determined for being indicative of any specific sort(s) of process problem, and/or defects, and/or distortions that may occur during any suitable types of printing processes.

In some embodiments, the marks shown in FIGS. 2A and 2B may be used in conjunction with additional tools for detecting distortions in the images printed in system 10. For example, processor 20 and/or the operator are configured to use the information received from image quality control station 55 in conjunction with the analysis of the graphic representation of the marks shown in FIGS. 2A and 2B.

FIG. 3 is a flow chart that schematically illustrates a method for using the marks of FIGS. 2A and 2B to identify problems in printing and distortions that occurred in images 42 printed on sheets 50, in accordance with an embodiment of the present invention.

The method begins at an image receiving step 100 with processor 20 receiving: (i) multiple product images, such as image 42, intended to be printed on multiple respective sheets 50, and (ii) one or more marks that are intended to be printed on the edges of sheets 50 (e.g., on the edge corresponding to side 21), as described in FIGS. 1 and 2 above.

At a printing step 102, processor 20 controls one or more printing assemblies of system 10 to: (i) print product images 42 on a predefined number of sheets 50, and (ii) print the marks on the edges of one or more of the sheets, as described in detail in FIGS. 1, 2A and 2B above.

At a stacking step 104, processor 20 controls stacking assembly 59 to stack the printed sheets 50 in output stack 88 having sides 21, 31, 41 and 51. In some embodiments, the marks printed on the edge of sheet 50 are visible on a side view of one or more of the sides (e.g., side 21) of output stack 88.

In some embodiments, when the plurality of sheets 50 are stacked on top of one another in output stack 88, the marks jointly form a pattern having a graphic representation of a problem may have occurred while printing images 50. In some cases, the problem may be caused by selecting a wrong printing job, so that the printed images do not have a distortion, but are located in a wrong position within output stack 88, as shown, for example by mark 23f of FIG. 2B above.

Additionally, or alternatively, the marks may be indicative of one or more distortions in one or more images 42 that are printed on respective sheets 50, as described in detail in FIG. 2B above.

At a reviewing step 106, the operator of system 10 checks, in a side view as described in FIGS. 2A and 2B above, at least a portion of one or more sides (e.g., side 21) of output stack 88. Sheets 50 in output stack 88 have: (i) multiple images 42 printed on multiple respective sheets 50, and (ii) the marks printed at least on the edge of (at least some of and typically all) sheets 50. The edge of the respective sheets 50 corresponds to side 21 and the marks that are visible on side 21 jointly form the graphic representation, as described in step 104 and in FIGS. 2A and 2B above. Additionally, or alternatively, processor 20 may receive (e.g., from a suitable camera or inspection system) a side-view image of side 21 of output stack 88, as described in FIG. 2A above.

At a side-view image analysis step 108, the operator and/or processor 20 may check, based on the marks shown on side 21, whether the graphic representation is indicative of one or more problems that occurred while printing one or more images 42 on one or more respective sheets 50. In some cases, the graphic representation in side 21 of output stack 88, is indicative of a distortion in one or more images 42 printed on respective sheets 50, as described in detail in FIGS. 2A and 2B above.

In some embodiments, steps 106 and 108 may be carried out after concluding all the printing jobs (e.g., printing jobs 33a-33d) shown in FIGS. 2A and 2B above.

In other embodiments, steps 106 and 108 may be carried while printing images 42 on sheets 50 and the marks on the edge of sheets 50 corresponding to side 21 (and optionally, other sides) of output stack 88, as described in FIGS. 2A and 2B above.

In case of identifying one or more problems in step 108, the method proceeds to a corrective action step 110 in which a corrective action is applied to system 10 for eliminating or reducing the identified problem(s), as described in FIG. 2B above.

In some embodiments, in case steps 106 and 108 are carried out after concluding all the printing jobs (e.g., printing jobs 33a, 33b, 33c and 33d), then step 110 terminates the method.

In other embodiments, in case steps 106, 108 and 110 are carried while printing images 42 on sheets 50 and the marks on the edge of sheets 50 corresponding to side 21 of output stack 88, the method loops back to step 102 in accordance with the following embodiments. In some embodiments, if no distortion and/or process problem are identified in step 108, the method loops back to step 102 for resuming the printing process of product images 42 on respective sheets 50, in accordance with the process recipe of each printing job (e.g., printing job 33d). Moreover, after applying the corrective action of step 110, the method loops back to step 102 for resuming the respective printing job, as described in FIG. 2B above. Thus, the loop back arrow between steps 110 and 102 is optional and depends on whether the operational mode of identifying the problems is carried out during the printing process, as described in FIGS. 2A and 2B above, or after concluding the printing process of printing jobs 33a-33d.

In alternative embodiments, before step 102 (e.g., during or before step 100) processor 20 is configured to define one or more properties of one or more of the marks intended to be printed on the edge(s) of sheets 50. The one or more properties may depend on one or more variables, such as but not limited to: (i) the image intended to be printed, (ii) the configuration of system 10, (iii) the type of substrate (e.g., sheet or continuous web), (iv) the printing fluids intended to be applied to blanket 44, and (v) parameters of the intended printing process.

In such embodiments, the properties may comprise at least one of: (i) the position of the one or more marks in the side view (e.g., of side 21), (ii) the size of the one or more marks in the side view (e.g., along the X-axis and/or the Y-axis of side 21, as shown in FIGS. 2A and 2B above), and (iii) the color of the one or more marks shown in the side view (e.g., of side 21).

Although the embodiments described herein mainly address digital printing using a flexible intermediate transfer member, the methods and systems described herein can also be used in other applications, such as in any sort of printing system and process that apply droplets of ink directly or indirectly to any suitable type of a target substrate, such as but not limited to: (i) paper sheets, (ii) folding cartons, (iii) multilayered polymers, and (iv) a continuous web.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
a printing assembly, which is configured to print: (i) multiple images on multiple respective substrates, and (ii) multiple marks on one or more edges of the multiple respective substrates; and
a stacking assembly, which is configured to stack the multiple respective substrates on top of one another to form a stack having a top surface parallel to one or more of the substrates, and sides made from the stacked edges of the substrates,
wherein, one or more of the marks are visible on a side-view of at least a given side of the sides,
and wherein at least a position of the one or more marks in the side view of the given side, is indicative of a problem that occurred while printing one or more of the multiple images.

2. The system according to claim 1, wherein the images comprise first and second images, the marks comprise first and second marks, and the substrates comprise first and second substrates, respectively, wherein: (i) on the first substrate, the first image is printed at an intended position and the first mark is printed at a first edge position on a given edge of the edges, and (ii) on the second substrate, the second image is printed at an actual position and the second mark is printed on the given edge at a second edge position.

3. The system according to claim 2, wherein the problem comprises an offset between the intended position and the actual position, and wherein, in the side-view image, a difference between the first and second edge positions is indicative of the offset between the actual position and the intended position.

4. The system according to claim 2, wherein the first image comprises a first color image of a first color and a second color image of a second color, different from the first color, wherein the first mark comprises: (i) a first color mark associated with the first color image and located at a first color position, and (ii) a second color mark associated with the second color image and located at a second color position different from the first color position, wherein the problem comprises a registration error between the first and second color images, and wherein, in the side-view image, a distance between the first and second color positions is indicative of the registration error between the first and second color images.

5. The system according to claim 2, wherein the problem comprises a movement of the second substrate relative to the second image, and wherein a difference between the first and second edge positions in the side-view image, is indicative of the movement.

6. The system according to claim 5, wherein the movement comprises a rotation of the second substrate about an axis orthogonal to the top surface.

7. The system according to claim 2, wherein the first image is printed on the first substrate using a first printing job, and the second image is intended to be printed on the second substrate using a second printing job, different from the first printing job, wherein the problem comprises an operational error of using the first printing job for printing the second image on the second substrate, and wherein a difference between the first and second edge positions is indicative of the operational error.

8. The system according to claim 1, and comprising a processor, which is configured to receive a side-view image of the side view, and to identify the problem based on at least the position of the one or more marks in the side-view image.

9. The system according to claim 8, wherein, before printing the multiple marks, the processor is configured to define one or more properties of the multiple marks intended to be printed on the one or more edges.

10. The system according to claim 9, wherein the one or more properties comprise at least one of: (i) the position of the one or more marks in the side view, (ii) a size of the one or more marks in the side view, and (iii) a color of the one or more marks in the side view.

11-15. (canceled)

16. A method, comprising:
printing: (i) multiple images on multiple respective substrates, and (ii) multiple marks on one or more edges of the multiple respective substrates; and
stacking the multiple respective substrates on top of one another to form a stack having a top surface parallel to one or more of the substrates, and sides made from the stacked edges of the substrates, wherein, one or more of the marks are visible on a side-view of at least a given side of the sides; and
identifying a problem that occurred while printing one or more of the multiple images, based on at least a position of the one or more marks in the side view of the given side, which is indicative of the problem.

17. The method according to claim 16, wherein the images comprise first and second images, the marks comprise first and second marks, and the substrates comprise first and second substrates, respectively, wherein: (i) on the first substrate, the first image is printed at an intended position and the first mark is printed at a first edge position on a given edge of the edges, and (ii) on the second substrate, the second image is printed at an actual position and the second mark is printed on the given edge at a second edge position.

18. The method according to claim 17, wherein identifying the problem comprises identifying an offset between the intended position and the actual position, and wherein, in the side-view image, a difference between the first and second edge positions is indicative of the offset between the actual position and the intended position.

19. The method according to claim 17, wherein printing the first image comprises printing a first color image of a first color and a second color image of a second color, different from the first color, wherein printing the first mark comprises printing: (i) a first color mark associated with the first color image and located at a first color position, and (ii) a second color mark associated with the second color image and located at a second color position different from the first color position, wherein identifying the problem comprises identifying a registration error between the first and second color images, and wherein, in the side-view image, a distance between the first and second color positions is indicative of the registration error between the first and second color images.

20. The method according to claim 17, wherein identifying the problem comprises identifying a movement of the second substrate relative to the second image, and
wherein a difference between the first and second edge positions in the side-view image, is indicative of the movement.

21. The method according to claim 20, wherein the movement comprises a rotation of the second substrate about an axis orthogonal to the top surface.

22. The method according to claim 17, wherein the first image is printed on the first substrate using a first printing job, and the second image is intended to be printed on the second substrate using a second printing job, different from the first printing job, wherein identifying the problem comprises identifying an operational error of using the first printing job for printing the second image on the second substrate, and wherein a difference between the first and second edge positions is indicative of the operational error.

23. The method according to claim 16, and comprising receiving a side-view image of the side view, and identifying the problem based on at least the position of the one or more marks in the side-view image.

24. The method according to claim 23, and comprising, before printing the multiple marks, defining one or more properties of the multiple marks intended to be printed on the one or more edges.

25. The method according to claim 24, wherein the one or more properties comprise at least one of: (i) the position of the one or more marks in the side view, (ii) a size of the one or more marks in the side view, and (iii) a color of the one or more marks in the side view.

26-30. (canceled)
